(19) United States
(12) Patent Application Publication
(10) Pub. No.: US 2024/0371537 A1
(43) Pub. Date: Nov. 7, 2024

(54) HIGH-INTENSITY FOCUSED ULTRASOUND APPARATUS AND METHOD FOR DECONTAMINATING SOLID RADIOACTIVE WASTE

(71) Applicants: ENESG CO., LTD., Daejeon (KR); KEPCO NUCLEAR FUEL CO., LTD., Daejeon (KR)

(72) Inventors: Unhak SEONG, Gyeongsangnam-do (KR); Jungcheol SHIN, Daejeon (KR); Namchan CHO, Daejeon (KR); Jungseok PARK, Sejong-si (KR); Chanjun PARK, Daejeon (KR); Yeongjong JOO, Daejeon (KR); Jeonghwan HONG, Daejeon (KR); Kitae KIM, Daejeon (KR); Jichang RYU, Daejeon (KR)

(73) Assignees: ENESG CO., LTD., Daejeon (KR); KEPCO NUCLEAR FUEL CO., LTD., Daejeon (KR)

(21) Appl. No.: 18/561,105

(22) PCT Filed: May 24, 2022
(86) PCT No.: PCT/KR2022/007337

§ 371 Date: Nov. 15, 2023

(30) Foreign Application Priority Data
May 31, 2021 (KR) 10-2021-0070361

(51) Int. Cl. G21F 9/30; B09B 3/30

(52) U.S. Cl. CPC G21F 9/30; B09B 3/30; G21F 9/28

(57) ABSTRACT

The present invention relates to an ultrasonic apparatus for decontaminating solid radioactive waste contaminated by radiation. The ultrasound apparatus for decontaminating solid radioactive waste includes: a container having a cylindrical shape; and a plurality of ultrasonic generators attached to an outer surface of a lower portion of the container and apart from each other at predetermined intervals, wherein in a state in which the container is filled with water, and the ultrasound apparatus decontaminates the solid radioactive waste by using ultrasonic waves generated from the plurality of ultrasonic generators, wherein the lower portion of the container has a downwardly-convex hemispherical shape, and the plurality of ultrasonic generators are attached to the hemispherical lower portion of the container such that ultrasonic waves generated from the plurality of ultrasonic generators may be focused on one point in the container.

### TECHNICAL FIELD

The present invention relates to an apparatus and method for decontaminating solid radioactive waste contaminated by radiation.

### BACKGROUND ART

Radioactive waste contaminated by radiation is generated in nuclear power plants, nuclear fuel production and nuclear cycle facilities, hospitals and industries using radiation sources, etc.

In particular, when facilities installed in nuclear power plants or nuclear fuel production facilities are replaced due to expiration, improvement, failure, or the like, a large amount of solid radioactive waste is generated.

Solid radioactive wastes such as metals, non-ferrous metals, plastics, and concrete are decontaminated by a physical or chemical method to lower the radioactive level thereof, and then sent to a storage facility which stores low-level and middle-level radioactive wastes. Solid radioactive waste, which is completely decontaminated, may be recycled.

In the related art, an ultrasonic method or a physical method is used for decontaminating solid radioactive waste.

However, ultrasonic decontamination methods of the related art are cleaning-level decontamination methods using normal ultrasonic waves and thus have a poor decontamination effect on solid radioactive wastes into which fine radioactive particles have penetrated deep or solid radioactive wastes having uneven complex shapes.

Therefore, there is a need for a high-intensity focused ultrasound decontamination apparatus capable of increasing cleaning intensity by focusing ultrasonic waves.

### PRIOR ART DOCUMENT

### Patent Document

Korean Patent Registration No. 10-1173276

### DISCLOSURE

### Technical Problem

Accordingly, the present invention was invented in view of the matters described above, and an objective of the present invention is to provide a high-intensity focused ultrasound apparatus and method for finely and completely decontaminating solid radioactive waste by focusing ultrasonic waves on the solid radioactive waste.

### Technical Solution

To achieve the objective of the present invention, an ultrasound apparatus for decontaminating solid radioactive waste includes: a container having a cylindrical shape with an open top; and a plurality of ultrasonic generators attached to an outer surface of a lower portion of the container and apart from each other at predetermined intervals, wherein in a state in which the container is filled with water, solid radioactive waste is put into the water, and the ultrasound apparatus decontaminates the solid radioactive waste by using ultrasonic waves generated from the plurality of ultrasonic generators.

In addition, the lower portion of the container has a downwardly-convex hemispherical shape, and the plurality of ultrasonic generators are attached to the hemispherical lower portion of the container such that ultrasonic waves generated from the plurality of ultrasonic generators may be focused on one point in the container.

In addition, the ultrasound apparatus further includes: a coupling container coupled to the container to accommodate the plurality of ultrasonic generators; and wheels installed on a lower portion of the coupling container.

According to another embodiment of the present invention, a method for decontaminating solid radioactive waste using ultrasonic waves includes: preparing a container having a cylindrical shape with an open top and a downwardly-convex hemispherical lower portion; attaching a plurality of ultrasonic generators to an outer surface of the lower portion of the container such that the plurality of ultrasonic generator are apart from each other at predetermined intervals; putting solid radioactive waste into water filled in the container; and decontaminating the solid radioactive waste by focusing ultrasonic waves generated from the plurality of ultrasonic generators on one point in the container.

### Advantageous Effects

According to the high-intensity focused ultrasound apparatus and method of the present invention, solid radioactive waste can be finely and completely decontaminated by focusing ultrasonic waves on the solid radioactive waste.

### DESCRIPTION OF DRAWINGS

FIG. 1 is a view illustrating an ultrasound apparatus according to an embodiment of the present invention.

FIG. 2 is a view illustrating ultrasonic generators accommodated in a coupling container of the ultrasound apparatus shown in FIG. 1.

FIG. 3 is an exploded view illustrating main components of the ultrasound apparatus shown in FIG. 1.

FIG. 4 is a vertical cross-sectional view illustrating the ultrasound apparatus of the present invention.

FIG. 5 is a view illustrating a state in which ultrasonic waves generated from the ultrasonic generators shown in FIG. 4 are focused.

FIG. 6 is a view illustrating a state in which radioactive waste is decontaminated using the ultrasound apparatus of the present invention.

FIG. 7 is a view illustrating support bars for holding radioactive waste according to the present invention.

FIG. 8 is a view illustrating that the radioactive waste shown in FIG. 6 can be moved in a horizontal or vertical direction using the support bars.

FIG. 9 is a view illustrating that radioactive waste can be rotated using the support bars of the present invention.

### MODE FOR INVENTION

Hereinafter, configurations and operations of the present invention will be described in detail according to preferred embodiments with reference to the accompanying drawings. When allocating reference numerals to elements in the drawings, like elements are denoted, if possible, with like reference numerals even though the elements are illustrated in different drawings.

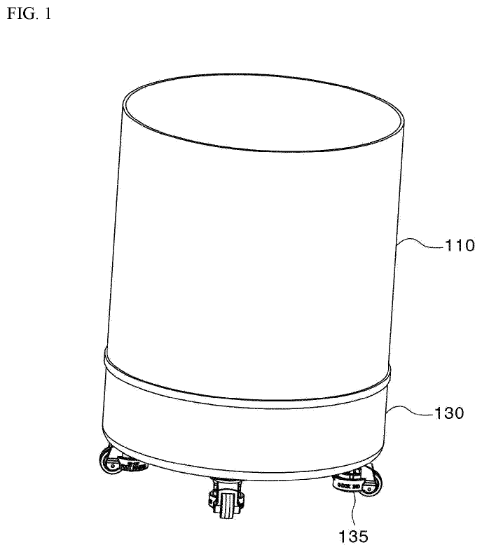

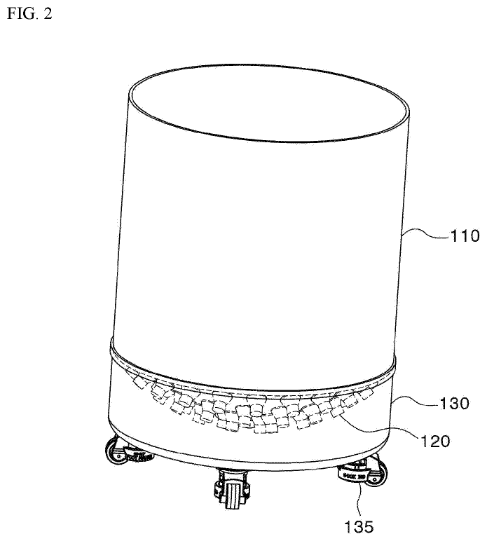

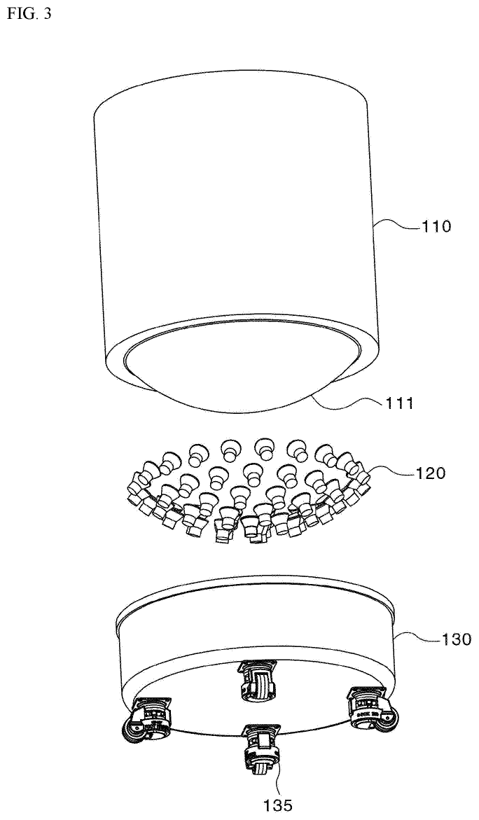

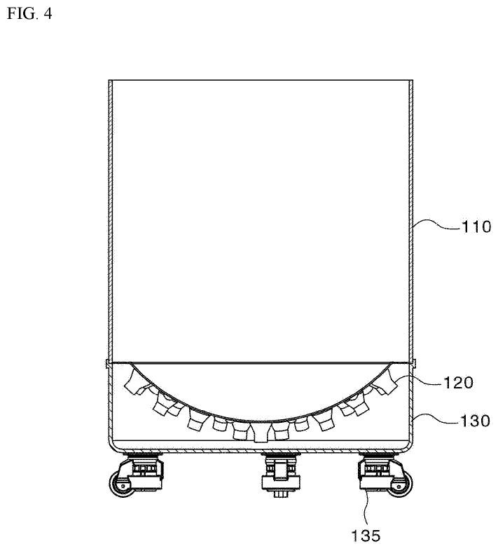

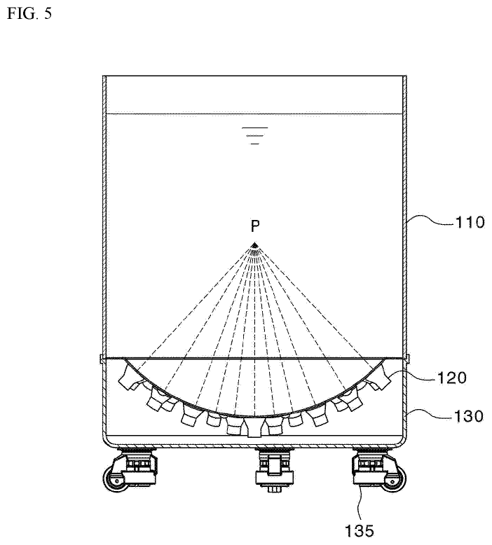

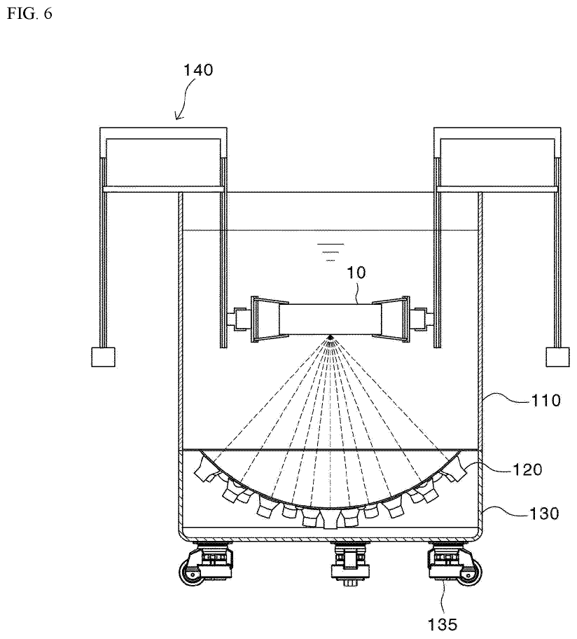

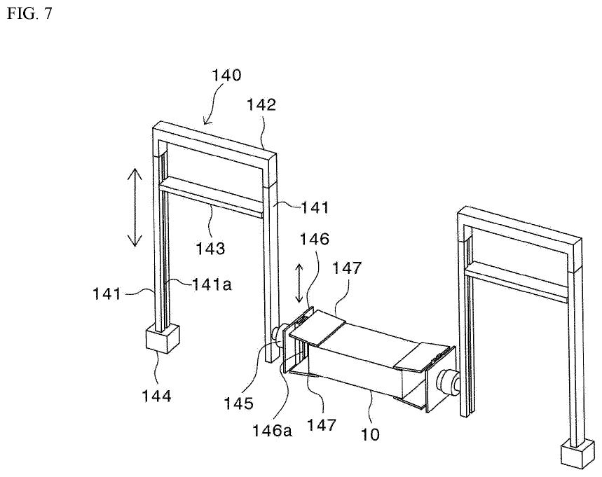

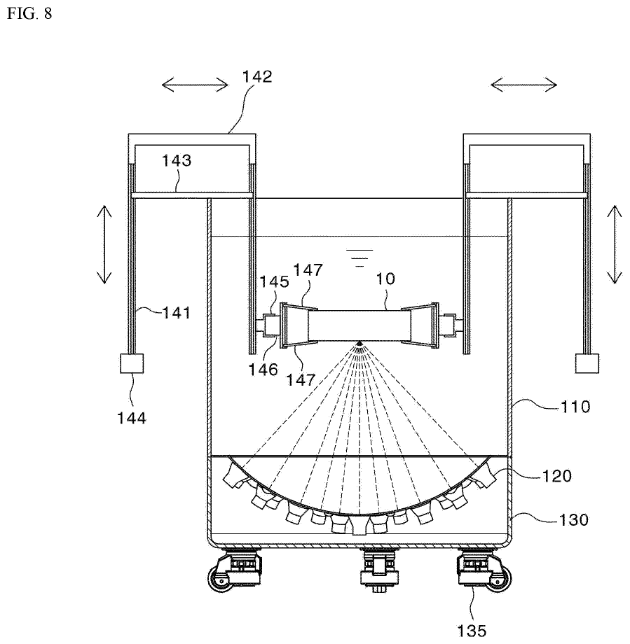

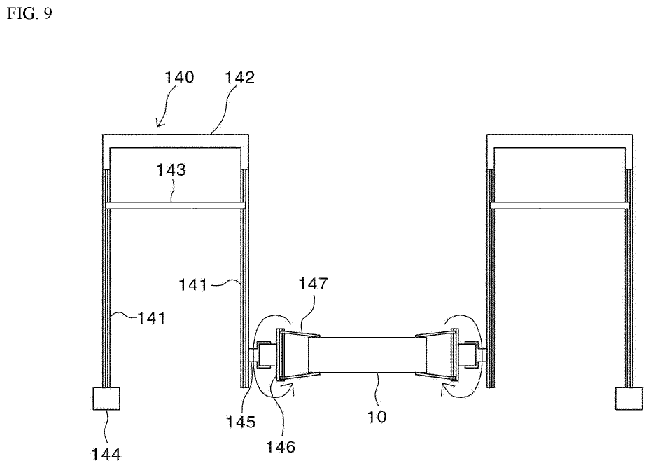

FIG. 1 is a view illustrating an ultrasound apparatus according to an embodiment of the present invention. FIG. 2 is a view illustrating ultrasonic generators 120 accommodated in a coupling container 130 of the ultrasound apparatus shown in FIG. 1. FIG. 3 is an exploded view illustrating main components of the ultrasound apparatus shown in FIG. 1. FIG. 4 is a vertical cross-sectional view illustrating the ultrasound apparatus of the present invention. FIG. 5 is a view illustrating a state in which ultrasonic waves generated from the ultrasonic generators 120 shown in FIG. 4 are focused. FIG. 6 is a view illustrating a state in which solid radioactive waste 10 is decontaminated using the ultrasound apparatus of the present invention. FIG. 7 is a view illustrating support bars 140 for holding the solid radioactive waste 10 according to the present invention. FIG. 8 is a view illustrating that the solid radioactive waste 10 shown in FIG. 6 can be moved in a horizontal or vertical direction using the support bars 140. FIG. 9 is a view illustrating that the solid radioactive waste 10 can be rotated using the support bars 140 of the present invention.

Referring to FIGS. 1 to 5, the ultrasound apparatus for decontaminating solid radioactive waste of the present invention (hereinafter referred to as ultrasound apparatus) includes a container 110, the ultrasonic generators 120, the coupling container 130, wheels 135, and the support bars 140.

The container 110 has a cylindrical shape with an open top and an accommodation space therein. A lower surface 111 of the container 110 has a hemispherical shape which is downwardly convex.

The ultrasonic generators 120 are devices for generating ultrasonic waves. The ultrasonic generators 120 are attached to the outer side of the lower surface 111 of the container 110 and are apart from each other at predetermined intervals therebetween.

Ultrasonic waves generated from the ultrasonic generators 120, which are arranged on the lower surface 111 having a hemispherical shape, may be focused on one point in the container 110. The focusing point of the ultrasonic generators 120 may be adjusted by varying the curvature of the lower surface 111 of the container 110.

The coupling container 130 is coupled to a lower portion of the container 110 to accommodate and protect the ultrasonic generators 120. The wheels 135 are installed on a lower portion of the coupling container 130 such that the ultrasound apparatus may move.

Ultrasound decontamination apparatuses of the related art are configured to generate weak ultrasonic waves and are thus limited to cleaning only the surface of radioactive waste. Therefore, ultrasound decontamination apparatuses of the related art are not suitable for performing fine and high-quality decontamination by penetration through the surfaces of metals.

According to the present invention, the container 110 is filled with water, and solid radioactive waste 10 is put into water. Then, the solid radioactive waste 10 is decontaminated using ultrasonic waves generated from the ultrasonic generators 120.

Ultrasonic waves generated from the ultrasonic generators 120 attached to the hemispherical lower surface 111 of the container 110 are focused on one point P to maximize the intensity of the ultrasonic waves, and thus the ultrasonic waves may penetrate the surfaces of metals and decontaminate even fine particles. Therefore, the solid radioactive waste 10, which cannot be decontaminated but only be cleaned in the related art, can be decontaminated finely and completely.

Accordingly, the solid radioactive waste 10 may be easily treated with low costs, and secondary radioactive byproducts may be produced in relatively small amounts compared to other physical decontamination methods, thereby realizing eco-friendly decontamination.

As shown in FIG. 6, according to the present invention, in the method for decontaminating solid radioactive waste using ultrasonic waves, the container 110 having a cylindrical shape with an open top and a downwardly-convex hemispherical lower portion is first prepared.

Next, the ultrasonic generators 120 are attached to the outer surface of the lower portion of the container 110 such that the ultrasonic generators 120 may be apart from each other at predetermined intervals.

Next, the container 110 is filled with water, and then solid radioactive waste 10 is put into water.

Next, the solid radioactive waste 10 is decontaminated by focusing ultrasonic waves generated from the ultrasonic generators 120 on one point in the container 110. The ultrasonic waves are focused on the surface of the solid radioactive waste 10.

The surface of the solid radioactive waste 10 is placed at the point on which the ultrasonic waves are focused, and thus the intensity of the ultrasonic waves is maximized. Therefore, the solid radioactive waste 10, which is hardly decontaminated by methods of the related art, may be easily decontaminated.

FIG. 7 shows the support bars 140 for supporting the solid radioactive waste 10 in water during decontamination.

Each of the support bars 140 includes: two vertical members 141 extending in a vertical direction and positioned at outer and inner sides in parallel with each other; and a horizontal member 142 connecting upper end portions of the two vertical members 141.

Rails 141a extending in the vertical direction are formed on inner surfaces of the two vertical members 141, and a movable member 143 is inserted into the rails 141a of the two vertical members 141 which are parallel to each other such that the movable member 143 may be moved along the rails 141a. After the movable member 143 is moved along the rails 141a to a given position, the movable member 143 may be fixed to the position by increasing friction between the movable member 143 and the rails 141a.

A weight 144 may be connected to a lower end portion of the outer one of the vertical members 141. The weight 144 applies a load to the vertical members 141 such that the support bar 140 may easily support the solid radioactive waste 10.

A hinge 145 is connected to a lower portion of the inner one of the vertical members 141, and a support part 146 is rotatably connected to the hinge 145.

A second rail 146a is formed on an inner surface of the support part 146, and a holder 147 is connected to the second rail 146a. The holder 147 includes an upper holder and a lower holder, and each of the upper and lower holders may be inserted into the second rail 146a and moved along the second rail 146a. After the holder 147 is moved along the second rail 146a to a given position, the holder 147 may be fixed to the position by increasing friction between the holder 147 and the second rail 146a.

The upper and lower holders of the holder 147 are used to hold and support an end portion of the solid radioactive waste 10. The upper holder and the lower holder of the holder 147 may be moved along the second rail 146a to support solid radioactive wastes 10 having various sizes.

Two support bars 140 may be supported on a wall surface of the container 110 to support the solid radioactive waste 10 put into water filled in the container 110.

Referring to FIG. 8, in a state in which the movable members 143 are supported on an upper end of the container 110, ultrasonic waves may be focused while moving the support bars 140 horizontally and vertically according to the size of the solid radioactive waste 10 as indicated with arrows.

As shown in FIG. 9, the holders 147 connected to the support parts 146 may be rotated on the hinges 145, and thus the solid radioactive waste 10 may be rotated to a desired angle in a supported state.

As described above, in a state in which the solid radioactive waste 10 is held on the support bars 140, the solid radioactive waste 10 may be moved horizontally and vertically and may be rotated. That is, according to the shape and size of the solid radioactive waste 10, the solid radioactive waste 10 may be moved to the point on which ultrasonic waves generated from the ultrasonic generators 120 are focused.

The present invention is not limited to the embodiments described above, and it will be apparent to those of ordinary skill in the art that various modifications or variations may be made without departing from the technical idea and scope of the present invention.

### DESCRIPTIONS OF REFERENCE NUMERALS

110: container
120: ultrasonic generator
130: coupling container
135: wheel
140: support bar
141: vertical member
141a: rail
142: horizontal member
143: movable member
144: weight
145: hinge
146: support part
146a: second rail
147: holder

1. An ultrasound apparatus for decontaminating solid radioactive waste, the ultrasound apparatus comprising:
a container having a cylindrical shape with an open top; and
a plurality of ultrasonic generators attached to an outer surface of a lower portion of the container and apart from each other at predetermined intervals,
wherein in a state in which the container is filled with water, solid radioactive waste is put into the water, and the ultrasound apparatus decontaminates the solid radioactive waste by using ultrasonic waves generated from the plurality of ultrasonic generators.

2. The ultrasound apparatus of claim 1, wherein the lower portion of the container has a downwardly-convex hemispherical shape, and
the plurality of ultrasonic generators are attached to the hemispherical lower portion of the container such that ultrasonic waves generated from the plurality of ultrasonic generators are focused on one point in the container.

3. The ultrasound apparatus of claim 2, further comprising:
a coupling container coupled to the container to accommodate the plurality of ultrasonic generators; and
wheels installed on a lower portion of the coupling container.

4. A method for decontaminating solid radioactive waste using ultrasonic waves, the method comprising:
preparing a container having a cylindrical shape with an open top and a downwardly-convex hemispherical lower portion;
attaching a plurality of ultrasonic generators to an outer surface of the lower portion of the container such that the plurality of ultrasonic generator are apart from each other at predetermined intervals;
putting solid radioactive waste into water filled in the container, and
decontaminating the solid radioactive waste by focusing ultrasonic waves generated from the plurality of ultrasonic generators on one point in the container.
